(19) United States
(12) Patent Application Publication
(10) Pub. No.: US 2022/0230768 A1
(43) Pub. Date: Jul. 21, 2022

(54) PRESSURE-CONTAINING SILO FOR A PRESSURISED WATER REACTOR NUCLEAR POWER PLANT

(71) Applicant: ROLLS-ROYCE SMR LIMITED, Derby (GB)

(72) Inventor: Daniel ROBERTSON, Derby (GB)

(73) Assignee: ROLLS-ROYCE SMR LIMITED, Derby (GB)

(21) Appl. No.: 17/614,165

(22) PCT Filed: May 13, 2020
(86) PCT No.: PCT/EP2020/063267

§ 371 Date: Nov. 24, 2021

(30) Foreign Application Priority Data
May 24, 2019 (GB) 1907379.0

(51) Int. Cl. G21C 13/024; G21C 15/18

(52) U.S. Cl. CPC G21C 13/024; G21C 15/18

(57) ABSTRACT

A pressure-containing silo for one or more components on a primary coolant circuit of a nuclear reactor having nuclear fuel assemblies cooled by coolant circulating the primary coolant circuit, the silo defining a release space which, in a loss-of-coolant accident releasing the pressurised coolant water from the one or more components therein, receives and contains the released water and steam, at increasing pressure, formed therefrom; wherein the silo is formed from plural, substantially identical, stacked and joined modular units, each having: a concrete body, a metal liner which lines a surface of the concrete body, and which, when the units are stacked and joined, is sealed edge-to-edge with metal liners of neighbouring units forming an inward-facing, pressure-containing skin surrounding the release space, and plural conduits which, when the units are stacked, align with the conduits of neighbouring units to receive elongate tensioning members for post-stressing the concrete of the bodies.

### FIELD OF THE DISCLOSURE

The present disclosure relates to the field of nuclear reactor power plants. In particular, the present invention relates to a pressure-containing silo for a reactor nuclear power plant.

### BACKGROUND

Nuclear power plants convert heat energy from the nuclear decay of fissile material contained in fuel assemblies into electrical energy. One exemplary type of nuclear power plant is a pressurised water reactor (PWR) nuclear power plant. PWR nuclear power plants have a primary coolant circuit which typically connects at least the following pressurised components: a reactor pressure vessel (RPV) containing the fuel assemblies; one or more steam generators; and one or more pressurisers. Coolant pumps in the primary circuit circulate pressurised water through pipework between these components. The RPV houses the nuclear reactor which heats the water in the primary circuit. The steam generator functions as a heat exchanger between the primary circuit and a secondary system where steam is generated to power turbines. The pressuriser typically maintains a pressure of around 155 bar in the primary circuit.

The aforementioned components and the primary circuit are located within an airtight containment structure which is designed to retain the primary circuit water and also any radioactive release in the event any of the components and/or the pipework of the primary circuit are compromised.

A conventional containment structure has an upright cylindrical shape with a hemispherical roof and encloses all of the pressurised components on the primary circuit. Containment structures for nuclear power plants with an output of 300-1000 MWe may have a diameter in the region of 20-35 m, which is considerably greater than the diameter of the RPV. The large size of conventional containment structures has a number of drawbacks.

For example, in the event of a loss-of-coolant accident, flash steam may be formed as high-pressure water leaks from the primary circuit into the containment structure. The steam continues to form until a pressure equilibrium is reached between the primary circuit and the pressure in the containment structure. However, the equilibrium pressure reached in the containment structure in a loss-of-coolant accident is typically around 4-5 bar, which is a substantially lower than the pressure of the water in the primary circuit. Consequently, a large amount of water leaks from the primary circuit before equilibrium is reached. This can cause the water level in the RPV to drop so that the fuel assemblies of the nuclear reactor are partially or completely uncovered, which thus necessitates the pumping of additional compensatory water into the RPV in order to prevent damage to the reactor or even a meltdown.

Another drawback of conventional containment structures is that they have a long construction lead time. Conventional containment structures are constructed from steel or post tensioned concrete and therefore require the use of significant formwork and scaffolding, as well as site-poured reinforced concrete and site-welded plate steel. Additionally, the construction process is highly dependent on numerous factors, making it vulnerable to delay and cost overruns. Furthermore, re-work can impose significant costs and delays.

A need exists for a nuclear power plant containment structure which addresses one or more of these drawbacks.

### SUMMARY OF THE DISCLOSURE

According to a first aspect there is provided a pressure-containing silo for one or more components on a primary coolant circuit of a nuclear power plant, the nuclear power plant having a nuclear reactor containing fuel assemblies; the pressure-containing silo defining a release space which, in the event of a loss-of-coolant accident releasing the pressurised coolant from the one or more components contained therein, receives and contains the released coolant;
wherein the silo is formed from plural, substantially identical, stacked and joined modular units, each modular unit having:
a concrete body,
a metal liner which lines a surface of the concrete body, and which, when the units are stacked and joined, is sealed edge-to-edge with the metal liners of neighbouring units to form an inward-facing, pressure-containing skin surrounding the release space, and
plural conduits which, when the units are stacked, align with the conduits of neighbouring units to receive elongate tensioning members for post-stressing the concrete of the bodies.

Advantageously, the concrete bodies of the modular units may be cast from moulds, which facilitates their manufacture on standardized production lines either on site or off site in controlled factory settings. The metal liners can be cast-in as part of such a moulding process. The metal liners may be formed from stainless steel or from other suitable corrosion and temperature-resistant metallic material. The stacking and joining of the modular units can also reduce the amount of rework which is required on site.

Another advantage is that the modular units can reduce overall construction times because they facilitate parallel construction of plural silos.

Yet another advantage is that the modular units may be sized so that they may be transported from a manufacturing location to site by conventional means such as road, rail, water or air.

Optional features of the first aspect will now be set out.

The pressure containing silo may be a close-fitting pressure containing silo. In embodiments, the close-fitting silo may have a diameter between 4 and 12 metres; or between 5 and 9 metres; or between 5 and 7 metres, or a range formed from any of the preceding endpoints. In embodiments, a close-fitting silo may be considered as a silo with a diameter between 0.2 m and 4 m larger than the diameter of the component it houses, or between 0.5 m and 2 m larger or between 1 m or 1.5 m larger, or a range of any of the preceding endpoints. In embodiments, a close-fitting pressure containing silo may be considered as a silo configured to contain pressures between 10 and 130 bar; or between 30 and 90 bar, or between 40 and 50 bar; or a range of any of the preceding end points.

Conveniently, each modular unit may further have alignment fixtures which engage with corresponding alignment fixtures of neighbouring units to ensure that the units, when stacked, are correctly located relative to each other. This may improve stacking accuracy and also may increase the rate at which modular units may be stacked together. Further it facilitates modifications to positioning to account for local conditions and settling. The alignment fixtures may take the form of corresponding male and female parts such as grooves and recesses, matching crenulations, or corresponding cone-shaped projections and recesses.

Conveniently each modular unit may further have alignment markings which align to corresponding alignment markings of neighbouring units to ensure that the units, when stacked, are correctly located relative to each other.

Conveniently, the elongate tensioning members may extend in three orthogonal directions in the aligned conduits.

The release space may be a cylindrical space. Such a shape is not only compatible with the pressure-retaining function of the silo but matches the generally cylindrical envelope of components such as an RPV, steam generator or pressuriser, and thus can help to reduce the volume of the release space. This in turn improves safety as a greater volume of water is retained in the primary circuit in the event of a loss of coolant accident. A close-fitting containment is also difficult to build using conventional concrete forming methods. The modular units of the present invention improve the ease of construction of a close-fitting containment, thereby reducing complexity, time and cost of construction.

Conveniently, even when the release space is a cylindrical space, the outer surface of the silo may have a (e.g. rectangular or hexagonal) prismatic shape. This facilitates the stacking together of adjacent silos without spaces being formed therebetween. The outer surface of the silo may be formed by faces of the concrete bodies.

Conveniently, when the release space is a cylindrical space and when the elongate tensioning members extend in three orthogonal directions in the aligned conduits, two of the orthogonal directions may be perpendicular to the cylinder axis and the third orthogonal directions may be parallel to the cylinder axis.

Conveniently, when the release space is a cylindrical space, the space may extend vertically, and may be capped at its upper end by a domed head. Such a domed head may be removably secured to the silo by bolting at the ends of elongate tensioning members which extend parallel to the cylinder axis. Alternatively, the release space may extend horizontally.

In use, the domed head may be removable by a crane located externally to the silo. This means the silo does not need to have increased height to accommodate a crane.

Optionally, a component which is contained within a pressure-containing silo may be fixed to the domed head to allow convenient insertion and removal of the component from the release space of the pressure-containing silo. If a pressure-containing silo contains plural components, then the components may be fixed to one another to allow convenient insertion and removal of the components from the release space of the pressure-containing silo.

When the release space is a cylindrical space, each modular unit may extend circumferentially around the release space by at least 60°. For example, each modular unit may extend circumferentially around the release space by 90° or 180° for compatibility with a rectangular prismatic shape for the outer surface of the silo, or by 60°, 120° or 180° for compatibility with a hexagonal prismatic shape for the outer surface of the silo.

The metal liners may be sealed edge-to-edge by welding, brazing, gaskets and/or mechanical fasteners.

Grouting may be inserted between faces of neighbouring modular units when the units are stacked. In this case, the modular units may have integral retention formations to shutter the inserted grouting.

The pressure-containing silo may contain the one or more components on the primary coolant circuit of the pressurised water nuclear reactor. For example, the pressure-containing silo may contain one of: an RPV, a steam generator, or a pressuriser.

The pressure-containing silo may also closely fit to the component to be contained within the silo, whereby the shape of bottom of the silo matches the base of the component. For example, if the component is the RPV with a hemispherical base, the bottom of the silo may also be hemispherical. The distance between the bottom of the silo and the base of the component may be between 0.1 m and 2 m larger than the diameter of the component it houses, or between 0.25 m and 1 m larger or between 0.5 m or 0.75 m larger, or a range of any of the preceding endpoints. This may reduce the volume of water of coolant leaked from the primary circuit that is required to cover the component.

The vessel diameter may be reduced at the bottom at the bottom to match reduced diameter elements such as reactor coolant pumps or reactor coolant pipes. Alternatively, the diameter of the silo may be reduced below component access hatches, compared to the diameter above the access hatches. Thus, the silo may be wider to an access hatch, then narrower thereafter. The distance between the wall of the silo to the component in a narrower region may be approximately half of the corresponding distance of a wider region. Alternatively, the distance may be between 0.1 m and 2 m; or between 0.25 m and 1 m; or between 0.3 m or 0.75 m larger.

According to a second aspect there is provided an array of plural of the pressure-containing silos of the first aspect, each silo being for containing respective components (e.g. an RPV, a steam generator or a pressuriser) on the primary coolant circuit of the PWR nuclear power plant, wherein components in neighbouring silos are connected by pipework of the primary coolant circuit to transfer the pressurised coolant water therebetween, the neighbouring silos having aligned apertures formed in selected of the modular units through which apertures the connecting pipework extends.

Optional features of the second aspect will now be set out.

Conveniently, the array may be arranged such that the neighbouring silos are in close contact such that the entire length of the connecting pipework between the release spaces of neighbouring silos is surrounded by the concrete bodies of the selected modular units of those neighbouring silos. In this way, the entire primary coolant circuit can be contained using only the silos, such that a further airtight containment structure surrounding the silos is not needed.

In examples of the array, a first one of the silos can be for containing a reactor pressure vessel of the PWR nuclear power plant, and a second one of the silos can be for containing a steam generator of the PWR nuclear power plant, in use the steam generator receiving pressurised coolant water from the nuclear reactor, extracting heat therefrom to generate steam for use in power generation, and returning the pressurised coolant water to the nuclear reactor; wherein the reactor pressure vessel is confined by and positioned within the first silo such that, in the event of the loss-of-coolant accident of the reactor pressure vessel, nuclear fuel elements within the nuclear reactor remain fully covered by the coolant water when the steam pressure within the release space of the first silo reaches an equilibrium level limiting further steam formation; wherein the steam generator is confined by the second silo such that, in the event of the loss-of-coolant accident of the steam generator, the nuclear fuel elements within the nuclear reactor remain fully covered by the coolant water when the steam pressure within the release space of the second silo reaches an equilibrium level limiting further steam formation; and wherein the release spaces of the first and second silos are isolated from each other such that the increasing pressure from the contained steam in either release space is not communicated to the other release space.

In these examples, the array may have further silos for containing respective further components, such as one or more further steam generator and/or a pressuriser. Each further component may be confined by its silo such that, in the event of a loss-of-coolant accident of the component, the nuclear fuel elements within the nuclear reactor remain fully covered by the coolant water when the steam pressure within the release space of the further silo reaches an equilibrium level limiting further steam formation. Further, the release space of each further silo can be isolated from the other silos such that the increasing pressure from the contained steam in its release space is not communicated to the other release spaces, and vice versa.

The pressure-containing silos may conveniently be identical in size. Alternatively, the pressure-containing silos may be sized differently from one another.

According to a third aspect there is provided a PWR nuclear power plant having a reactor pressure vessel containing fuel assemblies which are cooled by pressurised coolant water circulating around a primary coolant circuit, components (e.g. the RPV, one or more steam generators and a pressuriser) of the power plant on the primary coolant circuit being contained in respective silos of the array of the second aspect.

According to a fourth aspect there is provided a kit of the modular units for forming the pressure-containing silo of the first aspect. Thus, the units of the kit are stackable and joinable to form the silo.

In a fifth aspect these is a method of manufacture of a pressure-containing silo for one or more components of a primary coolant circuit of a nuclear power plant. The silo may be a silo according to the first aspect. The nuclear power plant has a nuclear reactor, the nuclear reactor containing fuel assemblies which are cooled by pressurised coolant circulating around the primary coolant circuit, the silo defines a release space which, in the event of a loss-of-coolant accident releasing the pressurised coolant from the one or more components contained therein. The method comprises providing a plurality of stacked and joined modular units. Each modular unit has a concrete body, comprising plural conduits to align with conduits of neighbouring units; and a metal liner which lines a surface of the concrete body. The method comprises stacking the modular units with the metal liners of neighbouring units forming an inward-facing, pressure-containing skin surrounding the release space, and with the conduits of neighbouring units aligned. The units are joined, and tensioning members inserted into the concrete bodies, the tensioning members then apply post stressing to the concrete of the bodies.

In embodiments, the joining of the units may comprise joining the metal liners edge-to-edge by welding, brazing, gaskets and/or mechanical fasteners. In embodiments, joining the units may comprise inserting grouting between faces of neighbouring modular units. In embodiments, grouting may be retained by integral retention formations on the modular units. In embodiments, a number of modular units may be joined together before being stacked to form the silo.

The present invention is described herein with reference to a pressurized water reactor, however it is applicable to any reactor comprising a pressurized coolant circulated in a primary circuit. Including, for example reactors utilizing a water coolant (including boiling water reactors), borated water, liquid metal or salt.

The nuclear reactor power plant may have a power output between 250 and 600 MW or between 300 and 550 MW.

The nuclear reactor power plant may be a modular reactor. A modular reactor may be considered as a reactor comprised of a number of modules that are manufactured off site (e.g. in a factory) and then the modules are assembled into a nuclear reactor power plant on site by connecting the modules together. Any of the primary, secondary and/or tertiary circuits may be formed in a modular construction.

The nuclear reactor of the present disclosure may comprise a primary circuit comprising a reactor pressure vessel; one or more steam generators and one or more pressurizer. The primary circuit circulates a medium (e.g. water) through the reactor pressure vessel to extract heat generated by nuclear fission in the core, the heat is then to delivered to the steam generators and transferred to the secondary circuit. The primary circuit may comprise between one and six steam generators; or between two and four steam generators; or may comprise three steam generators; or a range of any of the aforesaid numerical values. The primary circuit may comprise one; two; or more than two pressurizers. The primary circuit may comprise a circuit extending from the reactor pressure vessel to each of the steam generators, the circuits may carry hot medium to the steam generator from the reactor pressure vessel, and carry cooled medium from the steam generators back to the reactor pressure vessel. The medium may be circulated by one or more pumps. In some embodiments, the primary circuit may comprise one or two pumps per steam generator in the primary circuit.

In some embodiments, the medium circulated in the primary circuit may comprise water. In some embodiments, the medium may comprise a neutron absorbing substance added to the medium (e.g., boron, gadolinium). In some embodiments the pressure in the primary circuit may be at least 50, 80 100 or 150 bar during full power operations, and pressure may reach 80, 100, 150 or 180 bar during full power operations. In some embodiments, where water is the medium of the primary circuit, the heated water temperature of water leaving the reactor pressure vessel may be between 540 and 670 K, or between 560 and 650 K, or between 580 and 630 K during full power operations. In some embodiments, where water is the medium of the primary circuit, the cooled water temperature of water returning to the reactor pressure vessel may be between 510 and 600 k, or between 530 and 580 K during full power operations.

The nuclear reactor of the present disclosure may comprise a secondary circuit comprising circulating loops of water which extract heat from the primary circuit in the steam generators to convert water to steam to drive turbines. In embodiments, the secondary loop may comprise one or two high pressure turbines and one or two low pressure turbines.

The secondary circuit may comprise a heat exchanger to condense steam to water as it is returned to the steam generator. The heat exchanger may be connected to a tertiary loop which may comprise a large body of water to act as a heat sink.

The reactor vessel may comprise a steel pressure vessel, the pressure vessel may be from 5 to 15 m high, or from 9.5 to 11.5 m high and the diameter may be between 2 and 7 m, or between 3 and 6 m, or between 4 to 5 m. The pressure vessel may comprise a reactor body and a reactor head positioned vertically above the reactor body. The reactor head may be connected to the reactor body by a series of studs that pass through a flange on the reactor head and a corresponding flange on the reactor body.

The reactor head may comprise an integrated head assembly in which a number of elements of the reactor structure may be consolidated into a single element. Included among the consolidated elements are a pressure vessel head, a cooling shroud, control rod drive mechanisms, a missile shield, a lifting rig, a hoist assembly, and a cable tray assembly.

The nuclear core may be comprised of a number of fuel assemblies, with the fuel assemblies containing fuel rods. The fuel rods may be formed of pellets of fissile material. The fuel assemblies may also include space for control rods. For example, the fuel assembly may provide a housing for a 17×17 grid of rods i.e. 289 total spaces. Of these 289 total spaces, 24 may be reserved for the control rods for the reactor, each of which may be formed of 24 control rodlets connected to a main arm, and one may be reserved for an instrumentation tube. The control rods are movable in and out of the core to provide control of the fission process undergone by the fuel, by absorbing neutrons released during nuclear fission. The reactor core may comprise between 100-300 fuel assemblies. Fully inserting the control rods may typically lead to a subcritical state in which the reactor is shutdown. Up to 100% of fuel assemblies in the reactor core may contain control rods.

Movement of the control rod may be moved by a control rod drive mechanism. The control rod drive mechanism may command and power actuators to lower and raise the control rods in and out of the fuel assembly, and to hold the position of the control rods relative to the core. The control rod drive mechanism rods may be able to rapidly insert the control rods to quickly shut down (i.e. scram) the reactor.

### BRIEF DESCRIPTION OF THE DRAWINGS

Embodiments will now be described by way of example only, with reference to the Figures, in which:

FIG. 1 shows a schematic perspective view of a PWR power plant;

FIG. 2 shows a perspective view of an array of pressure-containing silos of the present invention;

FIG. 3A-3E show a plan view of a number of arrangements of the pressure-containing silos of the present invention;

FIG. 4 shows a perspective view of a modular unit of the present invention;

FIG. 5 shows a perspective view of a domed head which caps a cylindrical release space of a pressure-containing silo of the present invention;

FIG. 6 shows steps in an example construction sequence for assembling the modular units to form a silo; and

FIG. 7 shows schematically a cross-section through an end piece for closing a non-opening end of a silo.

### DETAILED DESCRIPTION

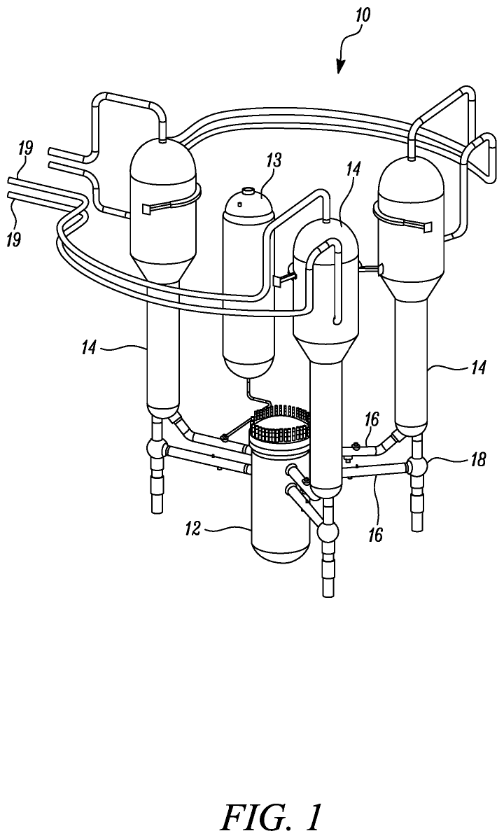

FIG. 1 is a schematic diagram of a PWR nuclear power plant 10 having an output which may be in the range from 300 to 1000 MWe. An RPV 12 containing fuel assemblies is centrally located in the plant. Clustered around the RPV are three steam generators 14 connected to the RPV by pipework 16 of the pressurised water, primary coolant circuit. Coolant pumps 18 circulate pressurised water around the primary coolant circuit, taking heated water from the RPV to the steam generators, and cooled water from the steam generators to the RPV.

A pressurizer 13 maintains the water pressure in the primary coolant circuit at about 155 bar.

In the steam generators 14, heat exchangers transfer heat from the pressurised water to feed water circulating in pipework 19 of a secondary coolant circuit, thereby producing steam which is used to drive turbines which in turn drive an electricity-generator. The steam is condensed before returning to the steam generators.

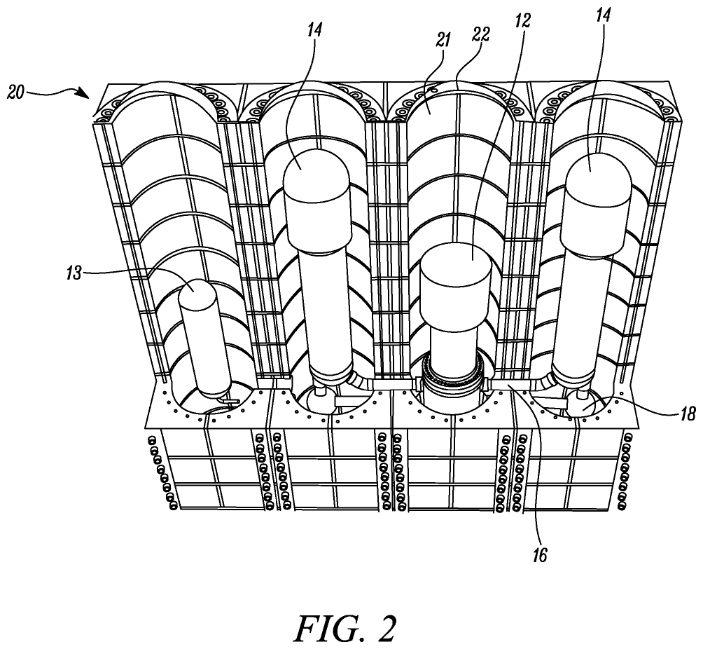

FIG. 2 shows an array 20 of vertically extending, pressure-containing silos 21 for components of a similar power plant. Each silo is capped with a respective domed head 22 and delimits an interior, cylindrical release space, having a typical diameter of about 5 to 7 m. In the example power plant of FIG. 2, an RPV 12, two steam generators 14 and a pressuriser 13 are located within the release spaces of respective silos and connected to one another by pipework 16 of the primary coolant circuit to transfer the pressurised coolant water therebetween. Neighbouring pressure-containing silos have aligned apertures in their walls through which the connecting pipework 16 extends. Coolant pumps 18 are also included on the primary circuit to drive the pressurised water around the primary coolant circuit.

In the event of a loss-of-coolant accident from one of the components 12, 13, 14, 18 or the pipework 16 of the primary circuit, pressurised coolant water is released into the release space of one of the silos. The released water forms steam which increases in pressure until it reaches an equilibrium level which inhibits further water release and steam formation. The water level in the RPV 12 drops during this release episode, but the pressure-containing silos 21 are configured such that, whichever silo receives the released water, the fuel assemblies within the RPV 12 remain fully covered by the coolant water over the entire episode. In particular, the cylindrical release spaces are relatively low in volume as they are approximately matched to the sizes of the components which they contain, and are also isolated from one another other such that the increasing pressure from the contained steam in a given release space is not communicated to the other release spaces. Relatively small components, such as the pressuriser 13 may not fully fill the release space of the silo 21 in which they are located. In this case, the remainder of the release space may be used to house additional equipment such as chemistry and volume control equipment, heat exchanger equipment, air conditioning equipment, and cooling water tanks.

The RPV 12 shown in FIG. 2 is for a small modular reactor (SMR) with an output of between 300-1000 MWe requires a silo with a diameter of between 5-7 m. In the event of a loss-of-coolant accident the equilibrium pressure for the pressure-containing silos 21 is approximately 30-50 bar.

An advantage of the silo arrangement over conventional PWR containment structures is that in the event of a loss-of-coolant accident, equilibrium pressure is reached much more rapidly than in conventional PWR containment structures and thus less coolant water is lost from the primary circuit, such that rapid refilling of water into the RPV to maintain coverage of the nuclear fuel assemblies maybe unnecessary.

As shown in FIG. 2, it is preferable that neighbouring pressure-containing silos 21 of the array 20 are in close contact such that the entire length of the connecting pipework 16 between the release spaces of the neighbouring silos is surrounded by the walls of the neighbouring pressure-containing silos. This close contact is facilitated by forming the silos with a prismatic outer surface. For example, the silos shown in FIG. 2 have rectangular prismatic outer surfaces, but another option for close-packing the silos is to form them with hexagonal prismatic outer surfaces.

As also shown in FIG. 2, the pipework 16 may have hot and cold legs which are arranged at spaced vertical heights with the silo walls having sufficient concrete ligaments between the apertures for the respective legs such that any hoop stress in the walls is kept below a safe predetermined level.

Other options are for the hot and cold legs of the pipework 16 to be arranged at the same vertical height with horizontally-spaced respective apertures, or to be arranged as coaxial, nested pipes. Having coaxial pipes for the respective legs advantageously reduces the number of apertures needed between neighbouring silos 21. When the silos are made of reinforced concrete (as discussed below), reducing the number of apertures advantageously reduces the need to reposition concrete reinforcement members.

Optionally, part of a boundary of the pressure-containing silo 21 containing the RPV 12 may comprise a heat exchanger configured to convey heat to an exterior of the silo. In the event of the loss-of-coolant accident in the RPV, the released steam condenses on the heat exchanger and runs back to the lowest part of the silo beneath the RPV. Thus, as water escapes the primary circuit, it fills the silo. A valve on the RPV can be set so that when the silo water pressure and the primary circuit water pressure are in a similar range, it opens, to equalise pressure and allow the water in the silo to flow back into the RPV. The silo bottom under the reactor vessel can be sized so that if the total water inventory of the primary circuit is emptied into its volume the reactor core will remain covered by water.

Another option, however, is for plural of the silos 21 to have respective such heat exchangers. In this case, the silos can be arranged to allow cross-flooding between the silos of the condensed steam in order that the water from the primary circuit can still run to the lowest part of the silo containing the RPV 12. Having more than one heat exchanger installed in different silos provides redundancy in case of damage or blockage to a heat exchanger.

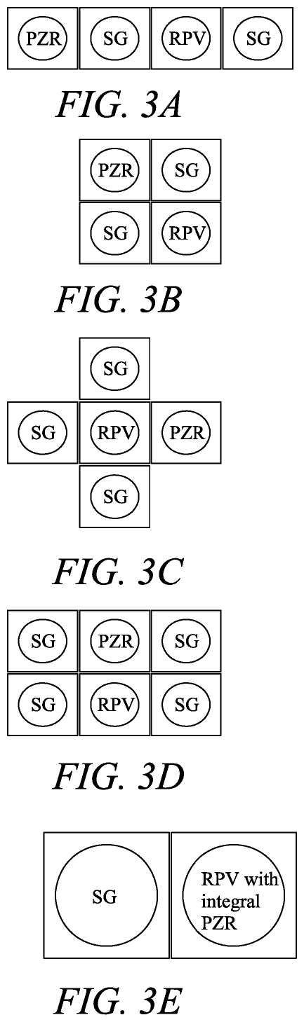

FIGS. 3A-3E show different possible close-packed arrangements of the pressure-containing silos 21 and the main components (i.e. RPV, steam generator SG, and pressurizer PZR) which they house. FIG. 3A shows the linear arrangement of FIG. 2. FIG. 3B shows a 2 by 2 square layout with two diagonally disposed steam generators. FIG. 3C shows a cross-shaped layout with three steam generators and a pressurizer surrounding a centrally positioned RPV. FIG. 3D shows a 2 by 3 rectangular arrangement with four steam generators located at the corners of the rectangle. FIG. 3E shows an arrangement which has only one steam generator, and the RPV and pressurizer (which may be integral with the RPV) are sized such that they are contained in the same silo.

Close-packed arrangements other than those shown in FIGS. 3A-3E are possible, for example if the silos 21 have non-rectangular (e.g. hexagonal prismatic) outer surfaces.

In other arrangements or more of the silos 21 may extend horizontally instead of vertically, and the components within those silos may be suitably adapted for a horizontal orientation.

The pressure-containing silos 21 shown in FIG. 2 are identical in size, however it is possible to have arrangements wherein the silos are differently sized.

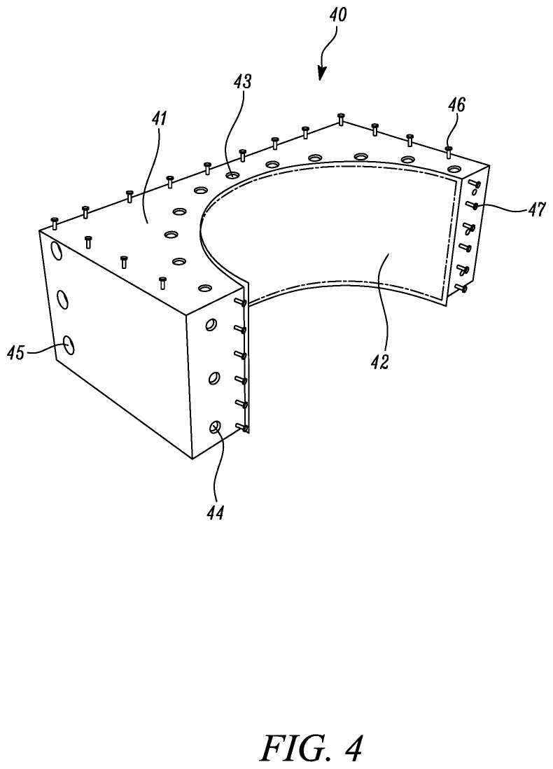

Each silo 21 is formed from plural, substantially identical, stacked and joined modular units. FIG. 4 shows a perspective view of one such modular unit 40 comprising: (i) a concrete body 41, (ii) a metal (e.g. stainless steel) liner 42 which lines a surface of the concrete body which, when the units are stacked and joined, is sealed edge-to-edge with the metal liners of neighbouring units to form an inward-facing, pressure-containing skin surrounding the release space, and (iii) plural conduits 43, 44, 45 which, when the units are stacked, align with the conduits of neighbouring units to receive elongate tensioning members for post-stressing the concrete of the bodies. Extended reinforcement (i.e. re-bar) 46, 47 projects from the surface of the concrete body of the modular unit. The extended reinforcements of neighbouring modular units are offset when the units are stacked so that they do not mechanically interfere with each other. When the units are joined together by grouting, the extended reinforcement thus fixes the thickness of the grouted joint and can also help to strengthen the joint. The modular unit shown in FIG. 4 extends circumferentially around the cylindrical release space of its silo by 180° and forms a rectangular prismatic outer surface of the silo. A variant unit also compatible with a rectangular prismatic outer surface has a 90° circumferential extent. If the silo has a hexagonal prismatic outer surface of the silo, the circumferential extent of the respective units can be 60°, 120° or 180°.

The modular units 40 can be manufactured by a moulding process. For example, the units can be cast by pouring concrete into a mould, followed by setting and release. Conveniently, the metal liners can be cast-in as part of such a moulding process. The moulding process facilitates the manufacture of the modular units on standardized production lines either on site or off site in a controlled factory setting.

Optional features may be included in the modular units 40. Examples are: alignment fixtures (e.g. cones and slots) which engage with corresponding alignment fixtures of neighbouring units to ensure that the units, when stacked, are correctly located relative to each other; alignment markings which align to corresponding alignment markings of neighbouring units to ensure that the units, when stacked, are correctly located relative to each other; sensors which function during the construction of the silos 21 from the units to monitor the handling of the units; sensors which monitor the silos in normal service and in accident scenarios; integral retention formations to shutter the grouting inserted between faces of neighbouring modular units when the units are stacked; integrated heat exchangers for cooling the release space defined by the silo which contains the RPV 12; and apertures in selected modular units through which pipework 16 extends.

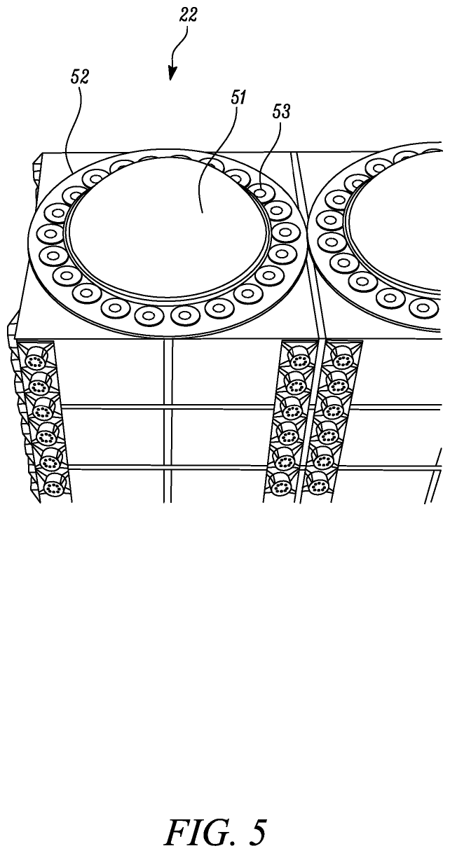

FIG. 5 shows a perspective view of one of the domed heads 22 of FIG. 2. The head has a dome portion 51 in the form of a depressed hemisphere which caps the cylindrical release space of the silo, and a surrounding bolting flange 52. The head, which may be formed of stainless steel, stainless steel-coated carbon steel, or even just suitably painted carbon steel, may have diameter of about 6 m and a thickness of about 60 mm. Conveniently, the head can be secured to the silo by bolting the ends of elongate tensioning members 53 which extend parallel to the cylinder axis through conduits 43 to the bolting flange 52. In other arrangements the domed head may be held in place by a bolting joint or by hinged pressure doors. The head is configured to resist anticipated pressure and temperature loads, without degrading during service.

Rather than securing the heads 22 to the silos 21 by bolting their flanges 52 to the ends of elongate tensioning members 53, other forms of closure can be adopted, such as forming the heads as hinged pressure doors.

In some arrangements, a component which is contained within a silo 21 can be fixed to the domed head 22 to allow convenient insertion and removal of the component from the release space of the pressure-containing silo. If a silo contains plural components, then the components can be fixed together to enable their combined insertion or removal in a single operation. For example, the reactor coolant pumps may be located beneath a steam generator, and therefore one potential method of maintenance of the coolant pumps is to unbolt the steam generator and lift the generator and reactor coolant pumps out of the reactor as one unit.

The bottom end of each silo 21 can be sealed using a concrete plug. The elongate tensioning members may wrap under or through the concrete plug to hold it in place.

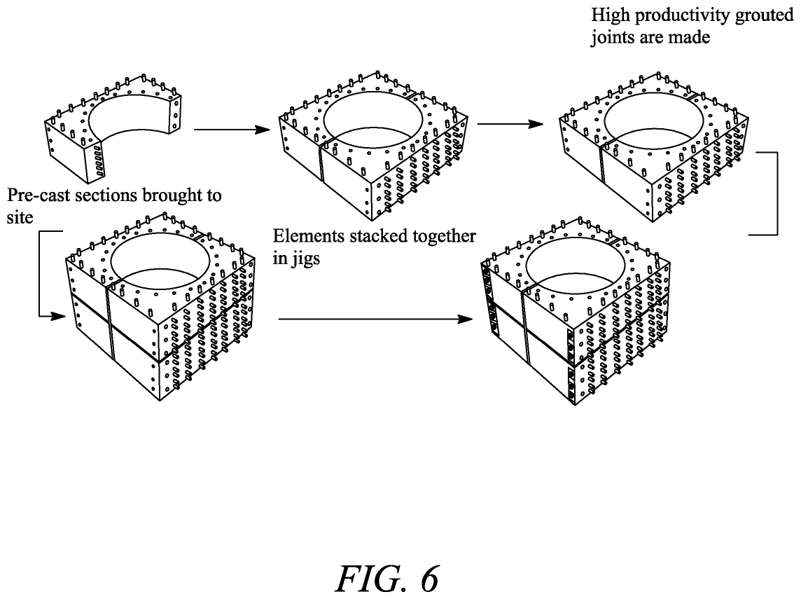

FIG. 6 shows steps in an example construction sequence for assembling the modular units 40 to form a silo 21.

The modular units 40 are firstly transported from a manufacturing location to a reactor site. The modular units can be sized so that they are transportable by road, rail, water or air. This allows the units to be manufactured at a location or locations away from the reactor site and then transported to a reactor site for assembly. Manufacture of modular units at more than one location allows standardized modular units to be manufactured in parallel which correspondingly reduces the overall construction times. Alternatively, the modular units may be manufactured at the reactor site.

The pre-cast units may then joined together by grouting them together using concrete. In this example the exposed re-bar (i.e. extended reinforcement 47) is configured so that when two pieces are placed in close proximity these re-bar overlap, whereby when the concrete grouting is set the two units are strongly bound together by the re-bar.

The modular pre-cast units may be placed directly into their final positions and then fixed in place. Pre-cast units may lifted by crane into their final positions. However, it can be more efficient to assemble two or four units together in a dedicated jig, where they can be precisely aligned, their liners 42 joined, the units grouted together and the completed assembly inspected, before the assembly is craned into position and bonded (i.e. by further welding and grouting) to other previously installed assemblies to build up the silo. Conveniently, the liners 42 are welded together edge-to-edge before the grouting. In this example, only two weld types (horizontal and vertical) need to be managed on site, which facilitates automated welding.

Once a silo is constructed, post tensioning cables (i.e. elongate tensioning members) are inserted within the conduits 43, 44, 45, before being tensioned. These post tensioned cables apply a large compressive load on the concrete of the units so that even when the silo is fully stressed in an accident scenario, the concrete remains under a compressive load.

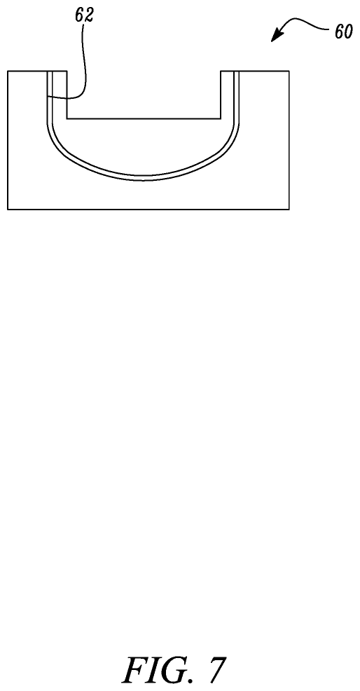

According to possible variants to the approach described above:
The steel liner 42 may incorporate features such as grooves and overlaps which allow it to be sealed to neighbouring liners without welding the liners together. These methods may involve methods such as elastomeric seals and infusing the joint with thermoplastic resins or brazing materials.
The steel liners 42 may be joined together by means of a bolting flange or other similar mechanical joint.
The units 40 may be joined without the use of grouting. For example, mechanical interlocks, such as grooves and crenulations, may be used to hold the units together, these joints being kept under compressive load in-service by the post tensioning cables and may include gaskets.
An end piece 60 for closing the non-opening end of the silo may be provided, as shown schematically in FIG. 7. The end piece can have one on more turn-around passages 62 through which the post tensioning cables can be inserted. This can then avoid a need for a cable stressing gallery at that end of the silo.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A pressure-containing silo for one or more components on a primary coolant circuit of a nuclear power plant having a nuclear reactor containing fuel assemblies which are cooled by pressurised coolant circulating around the primary coolant circuit, the silo defining a release space which, in the event of a loss-of-coolant accident releasing the pressurised coolant from the one or more components contained therein, receives and contains the released coolant;
wherein the silo is formed from plural, substantially identical, stacked and joined modular units, each modular unit having:
a concrete body,
a metal liner which lines a surface of the concrete body, and which, when the units are stacked and joined, is sealed edge-to-edge with the metal liners of neighbouring units to form an inward-facing, pressure-containing skin surrounding the release space, and
plural conduits which, when the units are stacked, align with the conduits of neighbouring units to receive elongate tensioning members for post-stressing the concrete of the bodies.

2. The pressure-containing silo according to claim 1, wherein each modular unit further has alignment fixtures which engage with corresponding alignment fixtures of neighbouring units to ensure that the units, when stacked, are correctly located relative to each other.

3. The pressure-containing silo according to claim 1, wherein each modular unit further has alignment markings which align to corresponding alignment markings of neighbouring units to ensure that the units, when stacked, are correctly located relative to each other.

4. The pressure-containing silo according to claim 1, wherein the elongate tensioning members extend in three orthogonal directions in the aligned conduits.

5. The pressure-containing silo according to claim 1, wherein the release space is a cylindrical space.

6. The pressure-containing silo according to claim 5, wherein two of the orthogonal directions are perpendicular to the cylinder axis and the third orthogonal direction is parallel to the cylinder axis.

7. The pressure-containing silo according to claim 5, wherein the cylindrical space extends vertically, and is capped at its upper end by a domed head.

8. The pressure-containing silo according to claim 7, wherein the domed head is secured to the silo by bolting at the ends of the elongate tensioning members which extend parallel to the cylinder axis.

9. The pressure-containing silo according to claim 5 wherein each of the modular units extends circumferentially around the cylindrical release space by at least 60°.

10. The pressure-containing silo according to claim 1, wherein the metal liners are sealed edge-to-edge by welding, brazing, gaskets and/or mechanical fasteners.

11. The pressure-containing silo according to claim 1, wherein grouting is inserted between faces of neighbouring modular units when the units are stacked.

12. The pressure-containing silo according to claim 11, wherein the modular units have integral retention formations to shutter the inserted grouting.

13. The pressure-containing silo according to claim 1 wherein the nuclear power plant is a PWR nuclear power plant and the pressure containing silo contains the one or more components on the primary coolant circuit of the PWR nuclear power plant.

14. An array of plural of the pressure-containing silos according to claim 1, each silo being for containing respective components on the primary coolant circuit of the PWR nuclear power plant, wherein components in neighbouring silos are connected by pipework of the primary coolant circuit to transfer the pressurised coolant water therebetween, the neighbouring silos having aligned apertures formed in selected of the modular units through which apertures the connecting pipework extends.

15. The array of claim 14, wherein the neighbouring silos are in close contact such that the entire length of the connecting pipework between the release spaces of neighbouring silos is surrounded by the concrete bodies of the selected modular units of those neighbouring silos.

16. The array of claim 14, wherein a first one of the silos is for containing a reactor pressure vessel of the PWR nuclear power plant, and a second one of the silos is for containing a steam generator of the PWR nuclear power plant, in use the steam generator receiving pressurised coolant water from the nuclear reactor, extracting heat therefrom to generate steam for use in power generation, and returning the pressurised coolant water to the nuclear reactor;
wherein the reactor pressure vessel is confined by and positioned within the first silo such that, in the event of the loss-of-coolant accident of the reactor pressure vessel, nuclear fuel elements within the nuclear reactor remain fully covered by the coolant water when the steam pressure within the release space of the first silo reaches an equilibrium level limiting further steam formation;
wherein the steam generator is confined by the second silo such that, in the event of the loss-of-coolant accident of the steam generator, the nuclear fuel elements within the nuclear reactor remain fully covered by the coolant water when the steam pressure within the release space of the second silo reaches an equilibrium level limiting further steam formation; and
wherein the release spaces of the first and second silos are isolated from each other such that the increasing pressure from the contained steam in either release space is not communicated to the other release space.

17. A PWR nuclear power plant having a reactor pressure vessel containing fuel assemblies which are cooled by pressurised coolant water circulating around a primary coolant circuit, components of the power plant on the primary coolant circuit being contained in respective silos of the array of claim 14.

18. A method for the manufacture of a pressure-containing silo for one or more components of a primary coolant circuit of a nuclear power plant, the nuclear power plant having a nuclear reactor containing fuel assemblies which are cooled by pressurised coolant circulating around the primary coolant circuit, wherein
the silo defining a release space which, in the event of a loss-of-coolant accident releasing the pressurised coolant from the one or more components is contained therein, the method comprising:
providing a plurality of stacked and joined modular units, each modular unit having:
a concrete body, comprising plural conduits to align with conduits of neighbouring units, and
a metal liner which lines a surface of the concrete body;
stacking the modular units with the metal liners of neighbouring units to form an inward-facing, pressure-containing skin surrounding the release space, and with the conduits of neighbouring units aligned;
joining the units; and
inserting tensioning members into the concrete bodies to apply a post stressing load to the concrete of the bodies of the modular units.

19. The method according to claim 18, wherein joining the units comprises joining the metal liners edge-to-edge by welding, brazing, gaskets and/or mechanical fasteners.

20. The method according to claim 18 wherein joining the units comprises inserting grouting between faces of neighbouring modular units when the units are stacked.

21. An array of plural pressure-containing silos for one or more components on a primary coolant circuit of a nuclear power plant having a nuclear reactor containing fuel assemblies which are cooled by pressurised coolant circulating around the primary coolant circuit, each silo in the array of plural pressure-containing silos being formed from plural, substantially identical, stacked and joined modular units, and being for containing at least one respective component on the primary coolant circuit of the nuclear power plant, wherein
components in neighbouring silos are connected by pipework of the primary coolant circuit to transfer the pressurised coolant water therebetween, each silo defining a release space which, in the event of a loss-of-coolant accident releasing the pressurised coolant from the component contained therein, receives and contains the released coolant, the neighbouring silos having aligned apertures formed in selected of the modular units through which apertures the connecting pipework extends.

22. The array of claim 21, wherein the nuclear power plant comprises a pressurised water reactor, PWR, and wherein a first one of the silos is for containing a reactor pressure vessel of the PWR nuclear power plant, and a second one of the silos is for containing a steam generator of the PWR nuclear power plant, in use the steam generator receiving pressurised coolant water from the nuclear reactor, extracting heat therefrom to generate steam for use in power generation, and returning the pressurised coolant water to the nuclear reactor;
wherein the reactor pressure vessel is confined by and positioned within the first silo such that, in the event of the loss-of-coolant accident of the reactor pressure vessel, nuclear fuel elements within the nuclear reactor remain fully covered by the coolant water when the steam pressure within the release space of the first silo reaches an equilibrium level limiting further steam formation;
wherein the steam generator is confined by the second silo such that, in the event of the loss-of-coolant accident of the steam generator, the nuclear fuel elements within the nuclear reactor remain fully covered by the coolant water when the steam pressure within the release space of the second silo reaches an equilibrium level limiting further steam formation; and
wherein the release spaces of the first and second silos are isolated from each other such that the increasing pressure from the contained steam in either release space is not communicated to the other release space.
